(19) United States
(12) Patent Application Publication
(10) Pub. No.: US 2015/0025657 A1
(43) Pub. Date: Jan. 22, 2015

(54) ELECTRONIC DEVICE

(71) Applicants: Sheng-Yang Peng, Hsinchu City (TW); Lee-Chun Guo, Hsinchu City (TW)

(72) Inventors: Sheng-Yang Peng, Hsinchu City (TW); Lee-Chun Guo, Hsinchu City (TW)

(73) Assignee: ITE TECH. INC., Hsinchu (TW)

(21) Appl. No.: 14/067,988

(22) Filed: Oct. 31, 2013

(30) Foreign Application Priority Data
Jul. 19, 2013 (TW) 102213727

(51) Int. Cl. G05D 15/01; G06F 1/16

(52) U.S. Cl. CPC G05D 15/01; G06F 1/1615
USPC 700/60

(57) ABSTRACT

An electronic device includes a first machine assembly, a second machine assembly, a first sensor, a second sensor, and a control circuit. The second machine assembly is pivoted to the first machine assembly. The first sensor is located on the first machine assembly and configured to generate first sensing data when the electronic device is in a non-normal working state. The second sensor is located on the second machine assembly and configured to generate second sensing data when the electronic device is in the non-normal working state. The control circuit is coupled to the first sensor and the second sensor and configured to perform a first default operation according to the first sensing data and the second sensing data.

### CROSS-REFERENCE TO RELATED APPLICATION

This application claims the priority benefit of Taiwan application serial no. 102213727, filed on Jul. 19, 2013. The entirety of the above-mentioned patent application is hereby incorporated by reference herein and made a part of this specification.

### BACKGROUND OF THE INVENTION

1. Field of the Invention

The invention relates to an electronic device.

2. Description of Related Art

The changing demands for an electronic device lead to the popularity of installing an accelerometer sensor, a light sensor, and/or a pressure sensor in the electronic device. By means of the different sensors, the electronic device is able to learn its tilted angle, ambient brightness, and/or ambient pressure and thereby performs corresponding functions.

In general, if one or more than one sensor is configured in the electronic device, an additional sensor hub is often required to be installed in the electronic device. The sensor hub is normally located between each sensor and a chip set or a central processor of the electronic device, so as to perform computation on sensing data from each sensor and transmit the computation result to the chip set or the central processor of the electronic device.

Nevertheless, if the electronic device is in a shutdown state, a standby state, or a dormancy state, the electronic device suspends the power supply to most electronic components (e.g., the sensor hub, the chip set, and the central processor) of the electronic device. Alternatively, the electronic device merely supplies a standby voltage to the chip set and the central processor for maintaining a few operations. Hence, when the electronic device is in the shutdown state, the standby state, or the dormancy state, the sensor hub located between each sensor and the chip set or the central processor of the electronic device frequently ceases to operate, and thereby the chip set or the central processor of the electronic device is not able to learn the sensing result of each sensor.

### SUMMARY OF THE INVENTION

The invention is directed to an electronic device in which sensors are able to be constantly functioned when the electronic device is in a non-normal working state.

In an embodiment of the invention, an electronic device that includes a first machine assembly, a second machine assembly, a first sensor, a second sensor, and a control circuit is provided. The second machine assembly is pivoted to the first machine assembly. The first sensor is located on the first machine assembly and configured to generate first sensing data when the electronic device is in a non-normal working state. The second sensor is located on the second machine assembly and configured to generate second sensing data when the electronic device is in the non-normal working state. The control circuit is coupled to the first sensor and the second sensor and configured to perform a first default operation according to the first sensing data and the second sensing data.

In view of the above, the electronic device described herein has machine assemblies (that may be lifted or shut) and at least two sensors which are able to be functioned in a normal manner when the electronic device is in the non-normal working state. If the electronic device is in the non-normal working state, the control circuit of the electronic device is able to learn whether the machine assemblies of the electronic device are lifted or shut by means of these sensors, so as to perform default operations according to whether the machine assemblies of the electronic device are lifted or shut.

Several exemplary embodiments accompanied with figures are described in detail below to further describe the invention in details.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating an electronic device according to an embodiment of the invention.

FIG. 2 is a schematic view illustrating an appearance of an electronic device according to an embodiment of the invention.

FIG. 3A and FIG. 3B are schematic views illustrating calculation of a value of an included angle between a first machine assembly and a second machine assembly of an electronic device according to an embodiment of the invention.

FIG. 4A, FIG. 4B, and FIG. 4C are schematic views illustrating an increase in a value of an included angle between a first machine assembly and a second machine assembly of an electronic device according to an embodiment of the invention.

FIG. 5A and FIG. 5B are schematic views illustrating a decrease in a value of an included angle between a first machine assembly and a second machine assembly of an electronic device according to an embodiment of the invention.

FIG. 6 is a schematic view illustrating an appearance of an electronic device according to another embodiment of the invention.

### DETAILED DESCRIPTION OF DISCLOSED EMBODIMENTS

In order for sensors of an electronic device to work as normal when the electronic device is in a non-normal working state, an embodiment of the invention is directed to an electronic device that is not equipped with a sensor hub between each sensor and a chip set or a central processor of the electronic device; instead, the electronic device described herein has sensors that are connected to a control circuit that is configured to control the electronic device to be in a power-on state, a shutdown state, a standby state, or a dormancy state. Thereby, in case that the electronic device is in the non-normal working state, e.g., the shutdown state, the standby state, or the dormancy state, the sensors of the electronic device are constantly functioned because the control circuit works in a normal manner.

In order to make the invention more comprehensible, embodiments are described below as examples to prove that the invention can actually be realized.

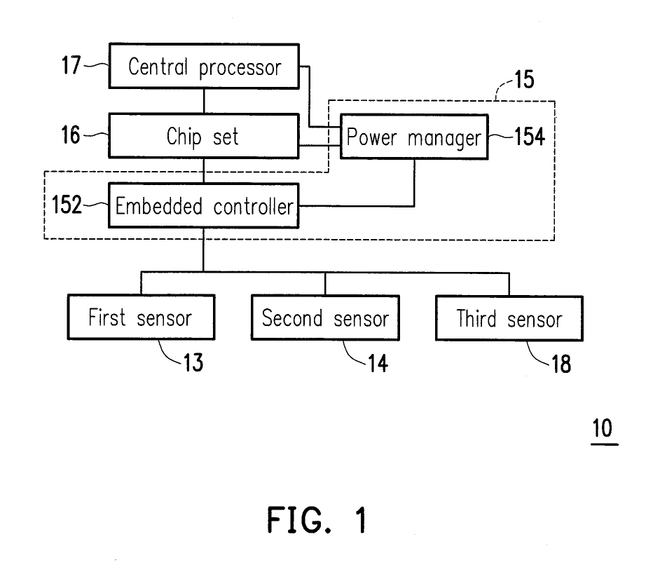

FIG. 1 is a schematic view illustrating an electronic device according to an embodiment of the invention. With reference to FIG. 1, the electronic device 10 is a mobile device or a mobile communication device of which the machine assemblies may be lifted or shut, for instance, and the invention is not limited thereto. For illustrative purposes, a notebook computer taken as an example of the electronic device 10 is provided below.

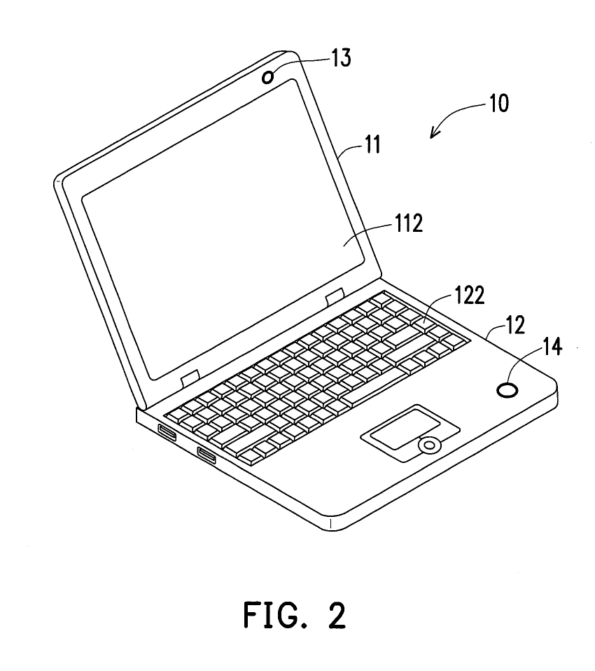

FIG. 2 is a schematic view illustrating an appearance of an electronic device according to an embodiment of the invention. With reference to FIG. 1 and FIG. 2, the electronic device 10 includes a first machine assembly 11, a second machine assembly 12, a first sensor 13, a second sensor 14, a control circuit 15, a chip set 16, and a central processor 17. The first machine assembly 11 may include a display panel 112, the second machine assembly 12 may include a keyboard 122, and the second machine assembly 12 is pivoted to the first machine assembly 11.

The first sensor 13 may be located on the first machine assembly 11. When the electronic device 10 is in a non-normal working state, e.g., a shutdown state, a standby state, or a dormancy state, the first sensor 13 may perform a sensing function and generate first sensing data. In the present embodiment, the first sensor 13 may include at least one accelerometer. Besides, the sensing function performed by the first sensor 13 is, for instance, an acceleration sensing function, so as to sense and detect a tilted state of the first machine assembly 11. As long as the tilted state of the first machine assembly 11 is sensed and detected, the actual location of the first sensor 13 on the first machine assembly 11 is not limited in the invention.

The second sensor 14 may be located on the second machine assembly 12 and configured to perform a sensing function and generate second sensing data when the electronic device 10 is in the non-normal working state. In the present embodiment, the second sensor 14 may include at least one accelerometer. Besides, the sensing function performed by the second sensor 14 is, for instance, an acceleration sensing function as well, so as to sense and detect a tilted state of the second machine assembly 12. As long as the tilted state of the second machine assembly 12 is sensed and detected, the actual location of the second sensor 14 on the second machine assembly 12 is not limited in the invention.

The control circuit 15 is coupled to the first sensor 13 and the second sensor 14 and configured to perform a first default operation according to the first sensing data and the second sensing data. For instance, the control circuit 15 is able to switch the electronic device 10 to be in a normal working state according to the first sensing data and the second sensing data when the electronic device 10 is in the non-normal working state. Besides, the control circuit 15 may be selectively located on the first machine assembly 11 or the second machine assembly 12; as long as the control circuit 15 may be coupled to the first sensor 13 and the second sensor 14, the actual location of the control circuit is not limited in the invention.

It should be mentioned that the non-normal working state described herein may include any state that allows the power consumption of the electronic device 10 to be saved and/or allows the working performance of the electronic device 10 to be reduced, e.g., the shutdown state, the standby state, and the dormancy state; by contrast, the normal working state described herein may include the power-on state and any other state that allows the electronic device 10 to achieve high performance. In another aspect, the first default operation not only includes an operation of switching the electronic device 10 to be in the normal working state from the non-normal working state but also comprises adaptive adjustment operations that may guarantee the comfort of a user, e.g., increase the chroma, the brightness, and the resolution of the display panel of the electronic device 10 and/or enhance the working performance of some or all electronic components in the electronic device 10, which will not be further described hereinafter.

To be specific, the control circuit 15 may receive the first sensing data from the first sensor 13 and receive the second sensing data from the second sensor 14. According to the first sensing data and the second sensing data, the control circuit 15 may calculate a value of an included angle between the first machine assembly 11 and the second machine assembly 12.

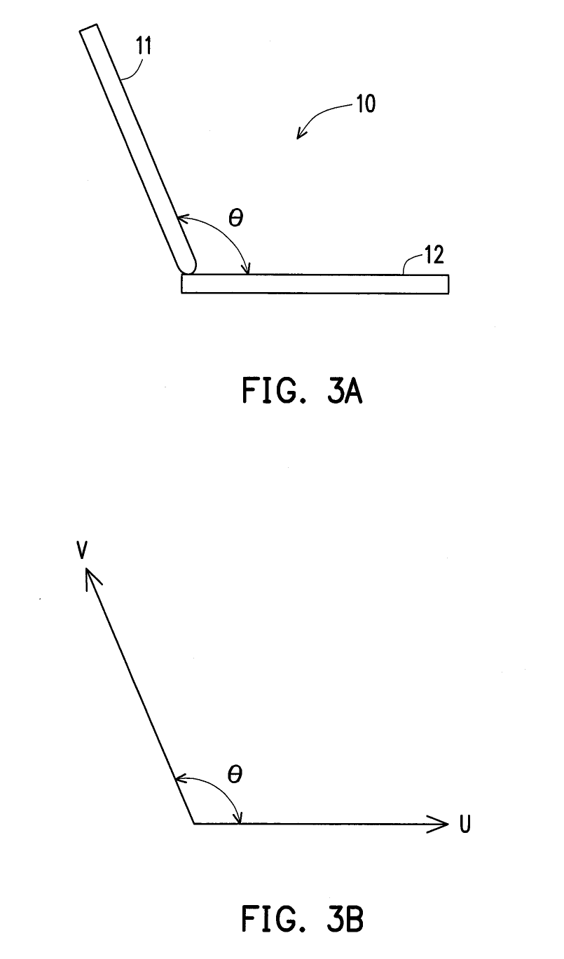

FIG. 3A and FIG. 3B are schematic views illustrating calculation of a value of an included angle between a first machine assembly and a second machine assembly of an electronic device according to an embodiment of the invention. With reference to FIG. 3A and FIG. 3B, it is assumed that an included angle between the first machine assembly 11 and the second machine assembly 12 of the electronic device 10 has a value θ. The first sensor on the first machine assembly 11 may generate the first sensing data including a first vector V, and the second sensor on the second machine assembly 12 may generate the second sensing data including a second vector U. The control circuit 11 may then calculate the value θ of the included angle according to the first vector V and the second vector U.

The control circuit 15 then determines whether the value θ of the included angle between the first machine assembly 11 and the second machine assembly 12 reaches a first value. If the value θ of the included angle between the first machine assembly 11 and the second machine assembly 12 reaches the first value, the control circuit 15 performs the first default operation. Specifically, the control circuit 15 may determine whether the value θ of the included angle between the first machine assembly 11 and the second machine assembly 12 is increased from a second value to the first value. If the value θ of the included angle between the first machine assembly 11 and the second machine assembly 12 is increased from the second value to the first value, the control circuit 15 performs the first default operation.

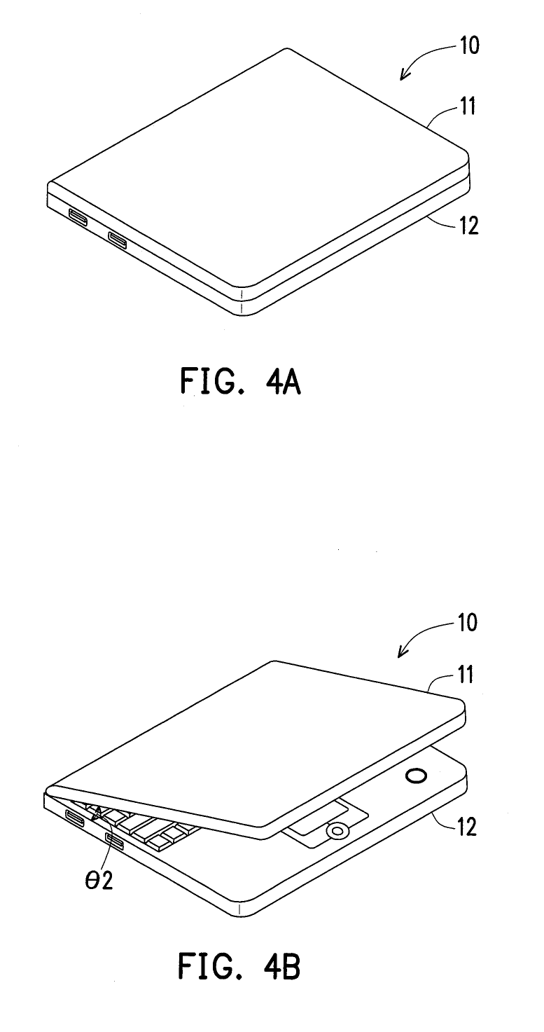

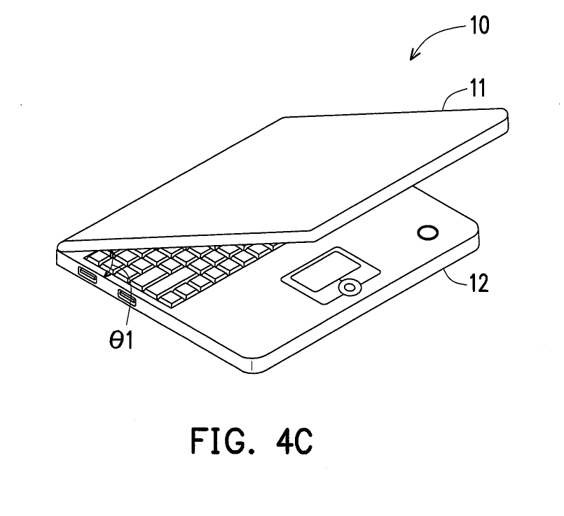

FIG. 4A, FIG. 4B, and FIG. 4C are schematic views illustrating an increase in a value of an included angle between a first machine assembly and a second machine assembly of an electronic device according to an embodiment of the invention. With reference to FIG. 4A, it is assumed that the first machine assembly 11 and the second machine assembly 12 of the electronic device 10 are shut (i.e., the value of the included angle between the first machine assembly 11 and the second machine assembly 12 approaches 0), and that the electronic device 10 is in the non-normal working state, e.g., the shutdown state, the standby state, or the dormancy state.

With reference to FIG. 4B and FIG. 4C, the value of the included angle between the first machine assembly 11 and the second machine assembly 12 is increased to the second angle θ2, e.g., a user may pull open the first machine assembly 11 and the second machine assembly 12. When the user continues to increase the value of the included angle between the first machine assembly 11 and the second machine assembly 12 from the second value θ2 to the first value θ1 or even more than the first value θ1, the control circuit 15 may switch the electronic device 10 to be in a normal working state (e.g., the power-on state) and adaptively increase the brightness of the display panel of the electronic device 10 and/or enhance the working performance of some or all electronic components of the electronic device 10 according to actual requirements. Besides, the first value θ1 may range from 5 degrees to 20 degrees, for instance, which may be adjusted according to actual requirements.

With reference to FIG. 1, the control circuit 15 may include an embedded controller 152 and a power manager 154. The embedded controller 152 is coupled to the first sensor 13 and the second sensor 14. When the electronic device 10 is in the non-normal working state, the embedded controller 152 may receive the first sensing data from the first sensor 13 and the second sensing data from the second sensor 14 and generate a control signal CS according to the first sensing data and the second sensing data.

For instance, the operation of determining whether the value of the included angle between the first machine assembly 11 and the second machine assembly 12 reaches the first value or the operation of determining whether the value of the included angle between the first machine assembly 11 and the second machine assembly 12 is increased from the second value to the first value may be performed by the embedded controller 152. When the embedded controller 152 determines that the value of the included angle between the first machine assembly 11 and the second machine assembly 12 reaches the first value or that the value of the included angle between the first machine assembly 11 and the second machine assembly 12 is increased from the second value to the first value, the embedded controller 152 may generate the control signal CS. In addition, the embedded controller 152 may also be replaced by another electronic component capable of performing computation, such as a microprocessor, a microcontroller, and so on; the invention is not limited thereto.

The power manager 154 is coupled to the embedded controller 152 and configured to receive the control signal CS. According to the control signal CS, the power manager 154 supplies a normal working voltage to the chip set 16, the central processor 17, and peripheral electronic devices (e.g., a mouse, a keyboard, and an external storage medium) of the electronic device 10, so as to switch the electronic device 10 to be in the normal working state.

From another perspective, the embedded controller 152 may also detect a power-on signal exemplarily generated by pressing a physical power-on button on the electronic device 10. If the embedded controller 152 detects the power-on signal, the embedded controller 152 may also generate the control signal CS.

Even when the electronic device 10 is in the normal working state, the first sensor 13 and the second sensor 14 may continue to perform the sensing functions. For instance, when the electronic device 10 is in the normal working state (e.g., the power-on state), the first sensor 13 and the second sensor 14 may respectively perform the sensing function, the first sensor 13 generates third sensing data, and the second sensor 14 generates fourth sensing data. According to the third sensing data and the fourth sensing data, the control circuit 15 performs a second default operation. For instance, the control circuit 15 is able to switch the electronic device 10 to be in a non-normal working state according to the third sensing data and the fourth sensing data when the electronic device 10 is in the normal working state.

Note that the second default operation not only includes an operation of switching the electronic device 10 to be in the non-normal working state from the normal working state but also comprises some adaptive adjustment operations, e.g., decrease the chroma, the brightness, and the resolution of the display panel of the electronic device 10 and/or reduce the working performance of some or all electronic components in the electronic device 10, which will not be further described hereinafter.

Particularly, the control circuit 15 may receive the third sensing data from the first sensor 13 and receive the fourth sensing data from the second sensor 14. According to the third sensing data and the fourth sensing data, the control circuit 15 may calculate a value of an included angle between the first machine assembly 11 and the second machine assembly 12. The control circuit 15 may then determine whether the value of the included angle between the first machine assembly 11 and the second machine assembly 12 is decreased from a third value (greater than a fourth value) to the fourth value. If the value of the included angle between the first machine assembly 11 and the second machine assembly 12 is decreased from the third value to the fourth value, the control circuit 15 performs the second default operation.

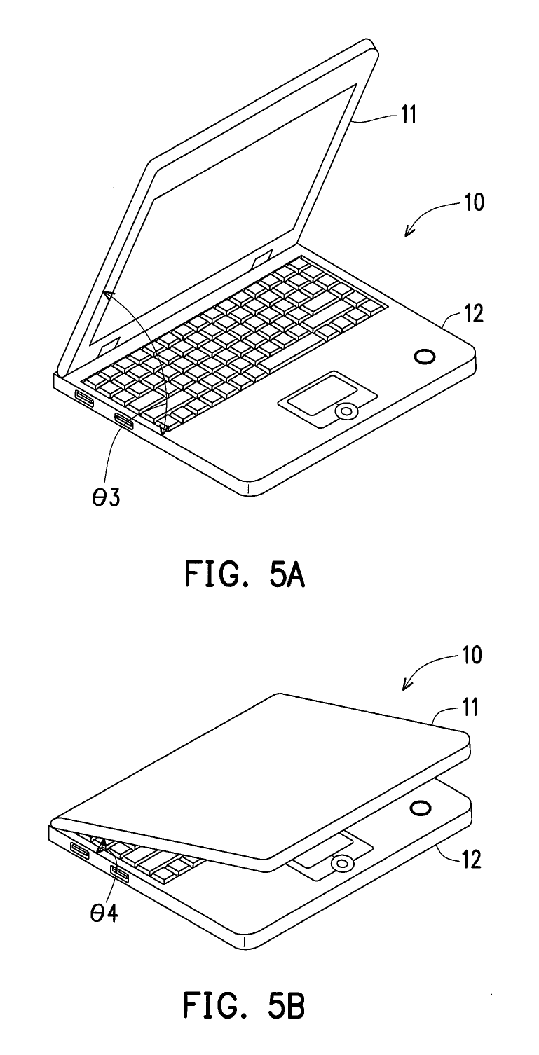

FIG. 5A and FIG. 5B are schematic views illustrating a decrease in a value of an included angle between a first machine assembly and a second machine assembly of an electronic device according to an embodiment of the invention. With reference to FIG. 5A, it is assumed that the electronic device 10 is in the normal working state (e.g., the power-on state), and that the value of the included angle between the first machine assembly 11 and a second machine assembly 12 is a third value θ3.

With reference to FIG. 5B, when a user slightly closes or shuts the first machine assembly 11 and the second machine assembly 12 to decrease the value of the included angle between the first machine assembly 11 and the second machine assembly 12 from the third value θ3 to the fourth value θ4 or even less than the fourth value θ4, the control circuit 15 may switch the electronic device 10 to be in a non-normal working state and adaptively decrease the brightness of the display panel of the electronic device 10 and/or reduce the working performance of some or all electronic components of the electronic device 10 according to actual requirements. Besides, the fourth value θ4 may range from 5 degrees to 20 degrees, for instance, which may be adjusted according to actual requirements.

It should be mentioned that the control circuit 15 described in the present embodiment constantly supplies the voltage required for an operation to the first sensor 13 and the second sensor 14 no matter whether the electronic device 10 is in the normal working state or in the non-normal working state, such that the first sensor 13 and the second sensor 14 remains functional as normal.

In addition to the first sensor 13 and the second sensor 14, the electronic device 10 may further include a third sensor 18. The third sensor 18 may be a light sensor and/or a pressure sensor, for instance. In the present embodiment, the third sensor 18 may be functioned as normal when the electronic device 10 is in the normal working state, and the third sensor 18 may stop being functional when the electronic device 10 is in the non-normal working state. Alternatively, no matter whether the electronic device 10 is in the normal working state or the non-normal working state, the control circuit 15 may constantly supply the voltage required for an operation to parts of the third sensor 18 or the entire third sensor 18, such that parts of the third sensor 18 or the entire third sensor 18 remains functional as normal.

However, the invention is not limited to the aforesaid embodiments. In another embodiment, the electronic device 10 may also be constituted by a combination of a mobile device or a mobile communication device equipped with a touch display panel (e.g., a tablet PC) and a base board equipped with a keyboard.

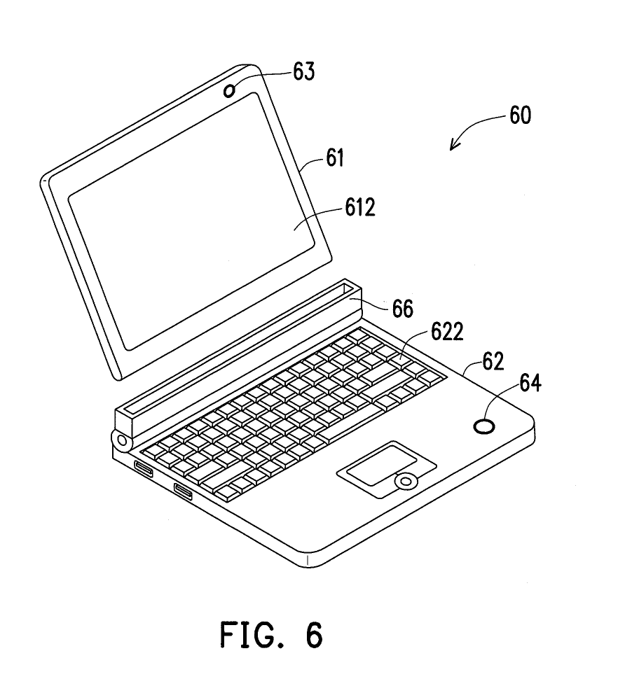

FIG. 6 is a schematic view illustrating an appearance of an electronic device according to another embodiment of the invention. With reference to FIG. 6, the electronic device 60 includes a first machine assembly 61 and a second machine assembly 62 that are detachable. The first 61 machine assembly 61 includes a touch display panel 612. Here, the touch display panel 612 may be a resistive touch display panel, a capacitive touch display panel, an optical touch display panel, an acoustic wave touch display panel, an electromagnetic touch display panel, and so on, which should not be construed as a limitation to the invention.

The second machine assembly 62 includes a keyword 622 and a slot 66. Here, the second machine assembly 62 may be pivoted to the first machine assembly 61 through the slot 66. For instance, the slot 66 may be installed on a proper side or in an adaptive portion of the first machine assembly 61, such that the first machine assembly 61 and the second machine assembly 62 may be electrically connected to each other. Note that the electronic device 60 depicted in FIG. 6 should not be construed as a limitation to the invention, and the detailed design of the first machine assembly 61, the second machine assembly 62, the slot 66, or other similar pivot mechanisms may be adjusted according to actual demands. The electronic device 60 may further include a first sensor 63, a second sensor 64, and a control circuit (not shown). Here, the first sensor 63 is identical or similar to the first sensor 13 shown in FIG. 1, the second sensor 64 is identical or similar to the second sensor 14 shown in FIG. 1, and the control circuit (not shown) of the electronic device 60 is identical or similar to the control circuit 15 shown in FIG. 1. Therefore, no repetitive descriptions are given hereinafter.

In the electronic device 60, the control circuit (not shown) may also be configured on the first machine assembly 61 or the second machine assembly 62. For instance, in an embodiment of the invention, the control circuit (not shown) of the electronic device 60 may be assembled to a central processor unit (CPU) and/or a chip set of the first machine assembly 61. Alternatively, the control circuit (not shown) of the electronic device 60 may also be configured on the second machine assembly 62. The invention should not be limited thereto.

To sum up, the electronic device described herein has the machine assemblies (that may be lifted or shut) and at least two sensors which are able to be functioned as normal when the electronic device is in the non-normal working state. If the electronic device is in the non-normal working state, the control circuit of the electronic device does not require any sensor hub and is still able to learn the sensing results of these sensors. Besides, according to these sensing results, the control circuit is able to learn whether the machine assemblies of the electronic device are lifted or shut, so as to perform default operations according to whether the machine assemblies of the electronic device are lifted or shut.

Although the invention has been described with reference to the above exemplary embodiments, it will be apparent to one of ordinary skill in the art that modifications to the described exemplary embodiments may be made without departing from the spirit of the invention. Accordingly, the scope of the invention will be defined by the attached claims and not by the above detailed descriptions.

What is claimed is:

1. An electronic device comprising:
a first machine assembly;
a second machine assembly pivoted to the first machine assembly;
a first sensor located on the first machine assembly and configured to generate first sensing data when the electronic device is in a non-normal working state;
a second sensor located on the second machine assembly and configured to generate second sensing data when the electronic device is in the non-normal working state; and
a control circuit coupled to the first sensor and the second sensor and configured to perform a first default operation according to the first sensing data and the second sensing data.

2. The electronic device as recited in claim 1, wherein the control circuit is configured to receive the first sensing data from the first sensor and receive the second sensing data from the second sensor,
wherein the control circuit is configured to calculate a value of an included angle between the first machine assembly and the second machine assembly according to the first sensing data and the second sensing data, and the control circuit performs the first default operation when the value of the included angle between the first machine assembly and the second machine assembly reaches a first value.

3. The electronic device as recited in claim 2, wherein the control circuit determines whether the value of the included angle between the first machine assembly and the second machine assembly is increased from a second value to the first value, and the control circuit performs the first default operation if the value of the included angle between the first machine assembly and the second machine assembly is increased from the second value to the first value.

4. The electronic device as recited in claim 1, wherein the control circuit is configured to switch the electronic device to be in a normal working state according to the first sensing data and the second sensing data when the electronic device is in the non-normal working state.

5. The electronic device as recited in claim 4, wherein the control circuit comprises:
an embedded controller coupled to the first sensor and the second sensor and configured to generate a control signal according to the first sensing data and the second sensing data when the electronic device is in the non-normal working state; and
a power manager coupled to the embedded controller and configured to receive the control signal, the power manager supplying a normal working voltage to a chip set and a central processor of the electronic device according to the control signal, so as to switch the electronic device to be in the normal working state.

6. The electronic device as recited in claim 1, wherein the first sensor is further configured to generate third sensing data when the electronic device is in a normal working state, and the second sensor is further configured to generate fourth sensing data when the electronic device is in the normal working state,
wherein the control circuit further performs a second default operation according to the third sensing data and the fourth sensing data.

7. The electronic device as recited in claim 6, wherein the control circuit is further configured to receive the third sensing data from the first sensor and receive the fourth sensing data from the second sensor,
wherein the control circuit is further configured to calculate the value of the included angle between the first machine assembly and the second machine assembly according to the third sensing data and the fourth sensing data,
wherein the control circuit is further configured to determine whether the value of the included angle between the first machine assembly and the second machine assembly is decreased from a third value to a fourth value, and the control circuit performs the second default operation if the value of the included angle between the first machine assembly and the second machine assembly is decreased from the third value to the fourth value.

8. The electronic device as recited in claim 6, wherein the control circuit is further configured to switch the electronic device to be in the non-normal working state according to the third sensing data and the fourth sensing data when the electronic device is in the normal working state.

9. The electronic device as recited in claim 1, wherein the control circuit continues to supply a voltage required for an operation to the first sensor and the second sensor when the electronic device is in the non-normal working state.

10. The electronic device as recited in claim 1, wherein the non-normal working state comprises a shutdown state, a standby state, a dormancy state, or a combination thereof.

11. The electronic device as recited in claim 1, wherein the first machine assembly comprises a display panel, the second machine assembly comprises a keyword, and the control circuit is located on the first machine assembly or the second machine assembly.

12. The electronic device as recited in claim 1, wherein the first machine assembly comprises a touch display panel, the second machine assembly comprises a keyword and a slot, the second machine assembly is pivoted to the first machine assembly through the slot, and the control circuit is located on the first machine assembly or the second machine assembly.

13. The electronic device as recited in claim 1, wherein each of the first sensor and the second sensor respectively comprises an accelerometer sensor.
